(19) United States
(12) Patent Application Publication
(10) Pub. No.: US 2019/0364731 A1
(43) Pub. Date: Dec. 5, 2019

(54) Rotary mower sickle blade

(71) Applicant: Jimmy Bollman, Oklahoma City, OK (US)

(72) Inventor: Jimmy Bollman, Oklahoma City, OK (US)

(21) Appl. No.: 16/501,939

(22) Filed: Jul. 8, 2019

Related U.S. Application Data
(62) Division of application No. 15/731,821, filed on Aug. 8, 2017.

(51) Int. Cl. A01D 34/73

(52) U.S. Cl. CPC A01D 34/73; A01D 2101/00

(57) ABSTRACT

A symmetrical sickle shaped lawnmower blade adapted to a rotary lawnmower to replace a common rectangular shaped blade provides a bilateral and horizontally curved cutting portion of the blade resulting in an enhanced vortex uplift airflow presented by the rotation of the blade within the lawnmower deck.

### CROSS REFERENCE TO RELATED APPLICATIONS

This is a divisional application claiming the benefit of U.S. patent application Ser. No. 15/731,821 filed on Aug. 8, 2017, by the same inventor.

### I. BACKGROUND OF THE INVENTION

### 1. Field of Invention

A symmetrical sickle shaped lawnmower blade adapted to a rotary lawnmower to replace a common rectangular shaped blade provides a bilateral and horizontally curved cutting portion of the blade resulting in an enhanced vortex uplift airflow presented by the rotation of the blade within the lawnmower deck.

### 2. Description of Prior Art

A preliminary review of prior art patents was conducted by the applicant which reveal prior art patents in a similar field or having similar use. However, the prior art inventions do not disclose the same or similar elements as the present sickle shaped rotary blade, nor do they present the material components in a manner contemplated or anticipated in the prior art.

Although no sickle shaped lawnmower blades were presented in the prior art, several include features that would affect the airflow created by the spinning blade for various airflow patterns, basically uplifting the cut grass underneath the mower decks. In U.S. Pat. No. 6,415,591 to Tylka, Sr., an overall flat rectangular blade is presented with a curved cutting edge and a bent pressed elevated fan portion on each bilateral cutting edge. The stated purpose of this blade design is to present a blade which cuts grass with a scything action. While Tylka presents a curved cutting blade, it is not sickle shaped nor does it present a smooth curved bend in each blade portion providing a different vortex airflow.

Other prior U.S. patents present overall rectangular blades with various cutting edge designs and curved or bent portions. In U.S. Pat. No. 6,052,979 to Tutschka, two sails on the same side of the blade as the cutting edges are included in a bilaterally symmetrical rectangular blade. A mulching blade with a flat cutting edge with an opposite side elevated hump is presented in U.S. Pat. No. 4,290,258 to Gobler. The shape of this blade and the position of the included elements are presented to mulch the cut grass repeatedly and to reduce the size of the cuttings until they are pulverized. A more efficient cutting edge is presented by a serrated flat cutting edge as claimed by Roth in U.S. Pat. No. 5,899,053. A non-rectangular circular blade is shown in a design patent to Gentile, U.S. Design Pat. No. D774,556, which has three radial cutting blade emanating from a central hub with an outer circular blade stabilizer provided on the outer end of the respective blades. A thatching blade is shown in U.S. Design Pat. No. D535,666 to Nesco which provides dangling resilient springs on a relatively flat rectangular blade which tear into the grass to eliminate stringers in the grass and any dormant thatch which might build up within the lawn grass, this thatching blade appearing to adapt to a rotary lawnmower for thatching a lawn instead of mowing the grass, although a grass cutting edge is shown in the drawings.

### II. SUMMARY OF THE INVENTION

Rotary powered lawnmowers cut grass on a horizontal plane using a blade which rotates on a vertical axis. These blades are provided in various lengths and with a variety of features which not only cuts grass; but may also mulch the cut grass, direct the grass to a side or rear discharge chute, bag the grass cuttings, or perform other lawn tasks in addition to the general mowing of the grass. All the blades, because of the high velocity rotation of the blade driven by a gas or electrical powered mower, require the blade to be bilaterally symmetrical and balanced. If a blade is not balanced, forced caused by the inertia of a spinning and unbalanced blade, can damage the motor or the shaft that connects the blade to the motor extending below some type of deck. These mowers are embodied with the same general components—a motor mounted above a mower deck, adjustable wheels on the mower deck which allow the deck to be positioned at a desired height for a desired grass cutting height, a shaft connected to the motor extending below the deck and above the ground, and a blade attached to the shaft which rotates on a level horizontal plane which cuts the grass, the blade having a sharpened portion on each end of the blade on the leading side of the blade. Blades of the prior art show the overall upper and lower profile of the blade as a rectangle, with the features disclosed in the prior art as noted. None of the prior art provide an S-shaped bilaterally symmetrical blade of the present invention with a sharpened edge on a first embodiment on the convex sides of the blade and/or a second embodiment on the concave sides of the blade, each blade having asymmetrical axial twist, which creates an enhanced uplift vortex airflow underneath the deck for an enhanced cutting and expulsion of the grass cuttings.

### III. DESCRIPTION OF THE DRAWINGS

The following drawings are submitted with this utility patent application.

FIG. 1 is a top view of a first embodiment of the S-shaped lawnmower blade for a rotary lawnmower.

FIG. 2 is a top view of a second embodiment of the S-shaped lawnmower blade for a rotary lawnmower.

FIG. 3 is a cross section of the S-shaped lawnmower blade for a rotary lawnmower along section lines 3/3 of FIG. 1.

FIG. 4 is a side sectional view of the S-shaped lawnmower blade for a rotary lawnmower attached to the shaft of the rotary lawnmower by a shaft bolt.

FIG. 5 is a top view of the third embodiment of the S-shaped lawnmower blade for a rotary lawnmower.

FIG. 6 is a cross section of the third embodiment of the S-shaped lawnmower blade for a rotary lawnmower along section lines 6/6 of FIG. 5.

### IV. DESCRIPTION OF THE PREFERRED EMBODIMENT

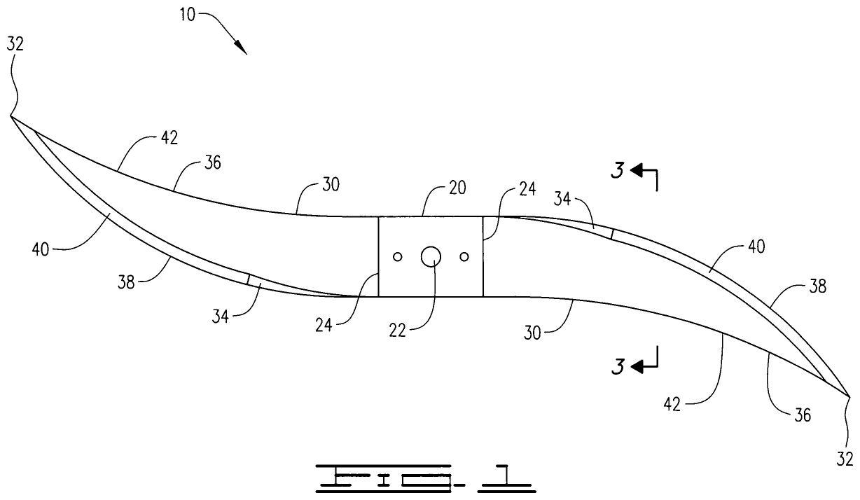

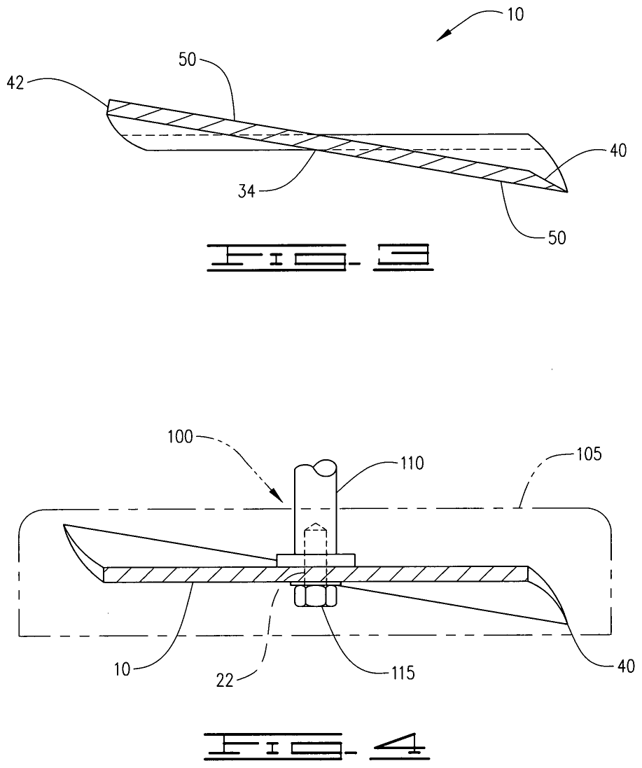

An S-shaped lawnmower blade 10 for a rotary lawnmower 100, shown in FIGS. 1-6 of the drawings, replaces rectangular shaped lawnmower blades, the S-shaped lawnmower blade 10, being bilaterally symmetrical and balanced, creates an enhanced uplift vortex airflow beneath the deck of a rotary lawnmower for improved cutting and expulsion of grass cuttings to a rear or side discharge port, for improved mulching capability and for bagging cut grasses and attaches to the rotary shaft 110 of the rotary lawnmower 100 to the rotary shaft 110 by a shaft bolt 115 below the lawn mower deck 105, FIG. 4.

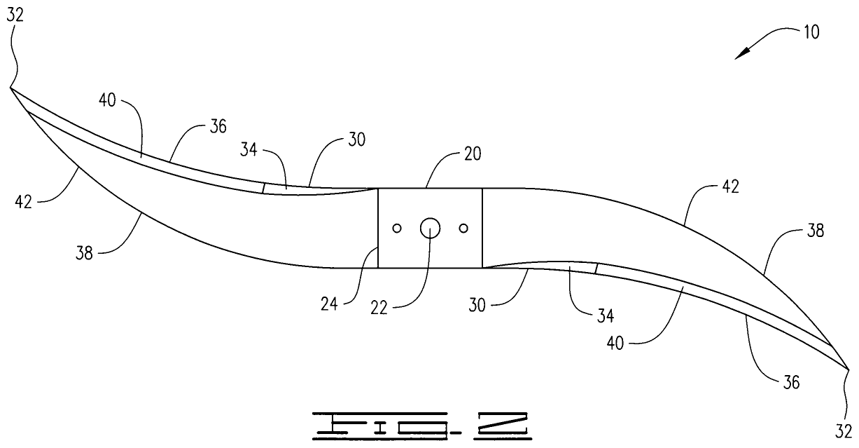

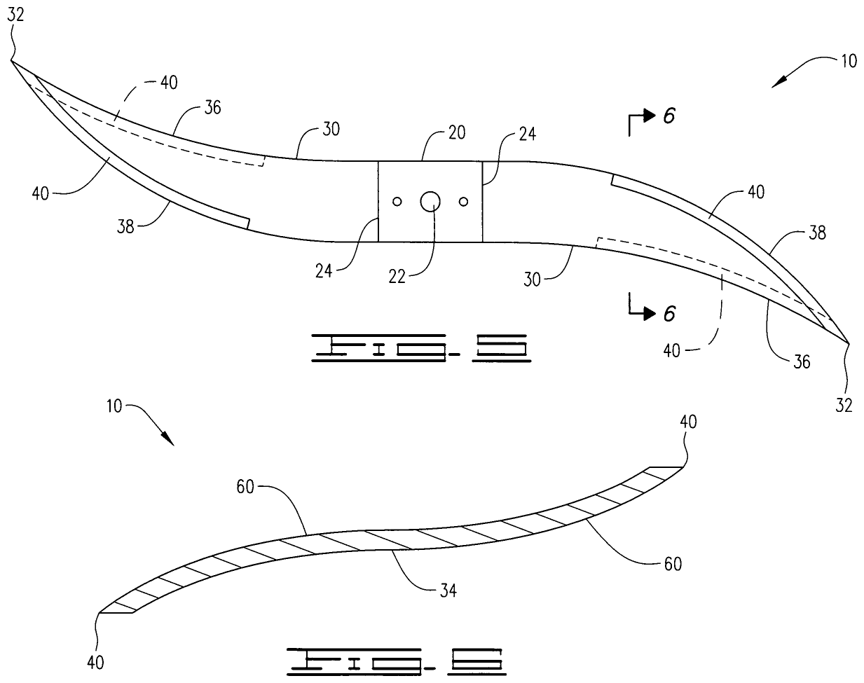

The S-shaped lawnmower blade 10 defines a flat rectangular horizontal center portion 20 with a central rotary shaft engagement bore 22 and opposing ends 24, two symmetrical sickle blades 30 extending from respective ends 24 of the horizontal center portion 20, terminating into a pointed end 32. Each sickle blade 30 includes an angular twist 34 and defines a concave edge 36 and a convex edge 38, FIG. 3. In a first embodiment, FIG. 1, the angular twist 34 presents each sickle blade 30 having a lower sharpened cutting margin 40 on the convex edge 38 of each sickle blade 30 and an upper flat margin 42 on the concave edge 36. In a second embodiment, FIG. 2, the angular twist 34 results in each sickle blade 30 having a lower sharpened cutting margin 40 on the concave edge 36 of each sickle blade 30 and an upper flat margin 42 on the convex edge 38. In a third embodiment, FIGS. 5 and 6, both the concave edge 36 and convex edge 38 may define a sharpened cutting margin 40, making the S-shaped lawnmower blade reversible, wherein a user may elect to install the S-shaped lawnmower blade 10 to present the cutting margin 40 on the convex edge 38 or elect to install the S-shaped lawnmower blade 10 to present the cutting margin 40 on the concave edges 36. In all three noted embodiments, the lower sharpened cutting margins 40 of each sickle blade 30 must be horizontally presented along a common horizontal plane in order to evenly cut the lawn.

A cross-sectional profile of each sickle blade 30 would include at least two embodiments. First, the cross-sectional profile of each identical sickle blade 30 beyond the angular twist 34 of each sickle blade 30, as indicated in FIG. 3, is a flat incline 50 which elevates as installed from the lower cutting margin 40 to either the upper flat margin 42 of the first and second embodiments, or the opposite cutting margins 40 not directed for use as installed of the side opposite the lower cutting margin 40. Alternatively, the cross-sectional profile of each identical sickle blade 30 beyond the angular twist of each sickle blade, as indicated in FIG. 6, has an S-shaped profile, presenting a multiple curved incline 60 which elevates from the lower cutting edge 40 to either the upper flat margins 42 of the first and second embodiments, or the opposite cutting edge 40 not directed for immediate presentation for grass cutting as installed as an upper oriented non-use lower cutting edge 40, FIGS. 5 and 6.

As the S-shaped lawnmower blade 10 rotates under the rotational power of the lawnmower motor and the lower extending rotary shaft 110 below the lawnmower deck 105 held in place by the shaft bolt 115, the lower cutting margin 40 of each sickle blade 30 is advanced into and through the grass below the lawnmower deck 105, FIG. 4. As the grass is cut, the grass and its cuttings are compelled upwards by an upward vortex airflow created by the high revolution rotation of the S-shaped lawnmower blade 10, wherein the grass cuttings are repeatedly elevated and repeatedly cut until such time as the grass cuttings fall to the ground in the event the grass is being mulched, or alternatively discharged through the side discharge or rear discharge into a grass bag attached to the rotary lawnmower 100.

The curvature of each sickle blade 30 forming the overall S-shape of the subject S-shaped lawnmower blade provides for a greater area of the S-shaped lawnmower blade exposed to the horizontal plane of travel of the sickle blades as they rotates versus that of the prior art rectangular shaped blade. The overall width and length of the S-shaped lawnmower blade 10 may be varied dependant upon the width of the lawnmower deck to which the S-shaped lawnmower blade 10 is attached. For example, the overall length of the S-shaped lawnmower blade 10 should have a travel diameter of 21″ when used with a lawnmower manufactured for a 21″ cut. For a lawnmower having a 28″ cutting width, the travel diameter of the S-shaped lawnmower blade 10 should not exceed 28″. In some instance, especially in large cutting widths of some riding rotary lawnmowers, there may be two or more blades underneath the deck of these mowers, which would require the use of two or more S-shaped lawnmower blades 10 to replace the two or more factory issued blades.

The bilateral symmetry of the S-shaped lawnmower blade 10 is imperative, in that the opposing sickle blades 30 must be equally balanced from the central rotary shaft engagement bore 22 in all directions, that the cutting margins 40 on each sickle blade 30 are the same pitch and length along the respective concave and/or convex margins 36,38 of the S-shaped lawnmower blade 10 to ensure harmonic balance of the S-shaped lawnmower blade 10 as it rotates at high speed below the lawnmower deck 105. The rotation of the S-shaped lawnmower blade 10, being bilaterally symmetrical, will be balanced and will produce little, if any, noticeable vibration or shaking within the lawnmower from the centripetal force or inertia occurring within the rotating S-shaped lawnmower blade 10.

The presenting angle and curvature of the present S-shaped lawnmower blade 10 directs each cutting margin 40 of each sickle blade 30 to slice through the grass with an angular cut, reducing tearing and damage to the grass. The flat cut of the prior art blades can tear and uproot grass instead of producing a clean cut, and can also bend the grass leaving an uneven cut. With the angular cut of each sickle blade 30 and the disclosed cutting profiles, the grass receives an even clean cut which lessens the damage and stress to the grass, and the clippings produced should be more fine and even which will enhance ejection of the clippings and also enhance decomposition and integration back into the lawn to preserve the nutritional benefits of mulching grass.

While the S-shaped lawnmower blade 10 for a rotary lawnmower 100 has been particularly shown and described with reference to a preferred embodiment thereof, it will be understood by those skilled in the art that changes in form and detail may be made therein without departing from the spirit and scope of the invention.

What is claimed is:

1. An S-shaped lawnmower blade for a rotary lawnmower attaching to a rotary shaft of said rotary lawnmower by a shaft bolt below a lawn mower deck of said rotary lawnmower, comprising:
a flat center portion defining a central shaft bore connecting to said rotary shaft of said lawnmower by said shaft bolt and opposing ends;
a pair of symmetrical sickle blades extending from each respective said end of said flat center portion, each said sickle blade defining a sharp end, a concave edge and a convex edge;
a lower cutting margin on said concave edge of each said sickle blade and an upper flat margin on said convex edge; and
an angular twist between each respective said lower cutting margin and said flat center portion presenting said lower cutting margin below said flat center portion and said upper flat portion above said flat center portion of each said sickle blade, with said cutting edges of both said sickle blades being aligned on a common horizontal plane below said lawnmower deck of said rotary lawnmower, wherein said S-shaped lawnmower blade, being bilaterally symmetrical and balanced, creates an enhanced uplift vortex airflow beneath the deck of a rotary lawnmower for improved cutting, reduced damage to lawn grasses and enhanced expulsion of the grass cuttings to a rear or side discharge port, for improved mulching capability and for bagging cut grasses.

2. The S-shaped lawnmower blade of claim 1, further comprising a profile of each said sickle blade defining a flat profile from said lower cutting margin to said upper flat margin.

3. The S-shaped lawnmower blade of claim 1, further comprising a profile of each said sickle blade defining an S-shaped curved inclined profile from said lower cutting margin to said upper flat margin.
